(19) United States
(12) Patent Application Publication
(10) Pub. No.: US 2015/0127416 A1
(43) Pub. Date: May 7, 2015

(54) SYSTEMS, METHODS AND COMPUTER READABLE MEDIA FOR MULTI-DIMENSIONAL RISK ASSESSMENT

(71) Applicant: Digital Risk Analytics, LLC, Maitland, FL (US)

(72) Inventors: Thomas Showalter, Maitland, FL (US); Stephen Thompson, Maitland, FL (US)

(73) Assignee: Digital Risk Analytics, LLC, Maitland, FL (US)

(21) Appl. No.: 14/296,420

(22) Filed: Jun. 4, 2014

Related U.S. Application Data
(60) Provisional application No. 61/899,156, filed on Nov. 1, 2013.

(51) Int. Cl. G06Q 10/06

(52) U.S. Cl. CPC G06Q 10/0635
USPC 705/7.28

(57) ABSTRACT

Some implementations can include a computerized method, system or computer readable media for multi-dimensional risk assessment. The method can include obtaining loan application data and preprocessing the loan application data including limit checking values and augmenting the loan application data with information from external sources. The method can further include selecting scoring values corresponding to key scoring variables and scoring the application by processing the scoring values in a multi-dimensional risk assessment system including an operational risk model.

### FIELD

Some implementations relate generally to risk assessment systems, and more particularly to systems, methods and computer readable media for multi-dimensional risk assessment.

### BACKGROUND

An assessment of risk can be used at numerous stages of a mortgage loan lifecycle, including origination, servicing, sale of a mortgage asset and loan modification. Many factors can influence risk and there can be many types of risk affecting a mortgage loan decision, including borrower risk, property risk, systemic risk and operational risk.

Some conventional loan risk assessment systems may rely on a single static score, such as a FICO credit score, which may indicate known historical borrower behavior. In these conventional systems, the score is often simply viewed in conjunction with a financial ratio, such as combined loan to value (CLTV), to make a lending decision. However, these systems may not take into account the ever-changing life factors that may discriminate among borrowers, influence operational risk, and may be necessary to understand and/or predict how those factors may affect the future. Further, these systems may not take into account systemic risk.

For example, during the U.S. mortgage crisis that occurred during the first decade of the 2000's, high FICO score borrowers that were encountering distress were defaulting in large numbers. Yet the mortgage industry continued to rely heavily on FICO scores to make loan and loan modification decisions.

The conventional risk assessment systems may not take into account the various types of risk that can be present at an individual, property, market, or economic system level. For example, risks associated with manufacturing defects in the loan application process may not be considered by conventional systems because these systems may lack the historical data or intelligence to recognize the potential and/or probability of manufacturing defect risk. Manufacturing defects can include errors and/or misrepresentations in information provided by loan applicants or obtained from other sources during the loan application and underwriting process.

A need may exist for a multi-dimensional risk assessment system that can provide a more holistic and dynamic assessment of risk including one or more of borrower risk, property risk, operational risk (e.g., manufacturing defect risk) and/or systemic risk.

Implementations were conceived in light of the above-mentioned needs, problems, and limitations, among other things.

### SUMMARY

Some implementations can include a computerized method for multi-dimensional risk assessment. The method can include obtaining, using one or more processors, loan application data. The method can also include preprocessing the loan application data, using the one or more processors, the preprocessing including limit checking values and augmenting the loan application data with information from external sources.

The method can further include selecting, using the one or more processors, scoring values corresponding to key scoring variables. The method can also include scoring the application, using the one or more processors, by processing the scoring values in a multi-dimensional risk assessment system including an operational risk model.

The method can further include generating a raw score based on the scoring. The method can also include applying, using the one or more processors, one or more policies and rules. The method can further include adjusting, using the one or more processors, the raw score based on a result of applying the one or more policies and rules.

The information from external sources can include one or more of credit reports, information from a Uniform Collateral Data Portal, information received via Uniform Loan Data Delivery and property data. The operational risk model can include a manufacturing defect risk assessment model.

The manufacturing defect risk assessment model can be trained with loan application data and at least one forensic audit finding. The manufacturing defect risk assessment model can include a Bayesian inference network. The forensic audit finding can include information about any misrepresentations or errors arising from loan manufacturing.

Some implementations can include a nontransitory computer readable medium having stored thereon software instructions that, when executed by a processor, cause the processor to perform operations. The operations can include obtaining loan application data and preprocessing the loan application data including limit checking values and augmenting the loan application data with information from external sources.

The operations can also include selecting scoring values corresponding to key scoring variables. The operations can further include scoring the application by processing the scoring values in a loan manufacturing defect risk model and generating a raw score.

The information from external sources can include one or more of credit reports, information from a Uniform Collateral Data Portal, information received via Uniform Loan Data Delivery and property data.

The operational risk model can include a manufacturing defect risk assessment model. The manufacturing defect risk assessment model can be trained with loan application data and at least one forensic audit finding.

The manufacturing defect risk assessment model can include a Bayesian inference network. The forensic audit finding can include information about any misrepresentations or errors arising from loan manufacturing.

Some implementations can include a computerized system having a processor configured, through software instructions stored on a nontransitory computer readable medium, to perform a series of operations. The operations can include obtaining loan application data and preprocessing the loan application data including limit checking values and augmenting the loan application data with information from external sources.

The operations can also include selecting scoring values corresponding to key scoring variables. The operations can further include scoring the application by processing the scoring values in a loan manufacturing defect risk model and generating a raw score.

The operational risk model can include a manufacturing defect risk assessment model. The manufacturing defect risk assessment model can be trained with loan application data and at least one forensic audit finding.

The manufacturing defect risk assessment model can include a Bayesian inference network. The forensic audit finding can include information about any misrepresentations or errors arising from loan manufacturing.

The manufacturing defect risk assessment model can also include one or more rules and one or more policies, wherein the one or more rules and one or more policies are configured to be applied to an output of the model to adjust a risk score produced by the model. The information from external sources can include one or more of credit reports, information from a Uniform Collateral Data Portal, information received via Uniform Loan Data Delivery and property data.

### BRIEF DESCRIPTION OF THE DRAWINGS

FIG. 1 is a diagram of an example loan manufacturing defect risk assessment environment in accordance with some implementations.

FIG. 2 is a flow chart of an example method for loan manufacturing defect risk assessment in accordance with some implementations.

FIG. 3 is a flow chart of an example method for loan manufacturing defect risk assessment model adaptation in accordance with some implementations.

FIG. 4 is a diagram of an example system for loan manufacturing defect risk assessment in accordance with some implementations.

FIG. 5 is a diagram of an example computing device configured for loan manufacturing defect risk assessment in accordance with some implementations.

FIG. 6 is a diagram of an example data flow for loan manufacturing defect risk assessment model building in accordance with some implementations.

FIG. 7 is a diagram of a multi-dimensional risk assessment system in accordance with some implementations.

FIG. 8 is a flow chart showing an example method for multi-dimensional risk assessment system in accordance with some implementations.

### DETAILED DESCRIPTION

In general, a multi-dimensional risk engine (or risk assessment system) can measure risk using one or more models that can be more discriminating, dynamic and holistic than conventional single dimension systems. For example, an implementation can include models for assessing systemic risk and indexes of operational risk. The multi-dimensional risk assessment system can use technology to capture and process information provided by people and processes, such as data obtained from forensic auditing of mortgage loans.

An implementation of a multi-dimensional risk assessment system can be used at numerous stages of a mortgage loan lifecycle, including origination, servicing, sale of a mortgage asset into a secondary market and loan modification. Also, an implementation can be used to estimate various types of risk affecting a mortgage loan decision, including borrower risk, property risk, systemic risk and operational risk.

Systemic risk can include the risk associated with collapse of an entire market or even an entire financial system. Systemic risk can rise from the various risks presented by linkages and interdependencies within the components of a system or market. In a system or market, the failure of a single entity or cluster of entities can cause a cascading failure, which could potentially bankrupt or bring down the entire system or market. An example of a cascading failure threatening an entire market or economy is the U.S. banking and mortgage crisis in the first decade of the 2000's.

Operational risk can include risks incurred by the internal activities, policies, procedures and rules of an organization. Operational risk includes the risks arising from the people, systems and processes through which a company operates. Operational risk can also include other classes of risk, such as fraud and legal risks. Also, operational risk can include the risk of loss resulting from inadequate or failed internal processes, people and systems.

Organizations typically try to manage operational risk to keep losses within a specific amount that the organization is prepared to accept in pursuit of business or other objectives. While businesses must accept that their people, processes and systems are imperfect, and that losses will arise from errors and ineffective operations, businesses can also utilize technology, such as a multi-dimensional risk assessment system, to help identify, predict and reduce operational risk.

An implementation of the multi-dimensional risk assessment system can take into account the various types of risk that can be present at an individual, property, market or economic system level. For example, risks associated with operations such as manufacturing defects in the loan application process can be considered because the multi-dimensional system may include models based on historical data or intelligence to recognize the potential for manufacturing defect risk. Manufacturing defects can include errors and/or misrepresentations in information provided by loan applicants or obtained from other sources during the loan application and underwriting process. Thus, the multi-dimensional risk assessment system, method or computer readable media can provide a more holistic and dynamic assessment of risk including borrower risk, property risk and operational risk (e.g., manufacturing defect risk).

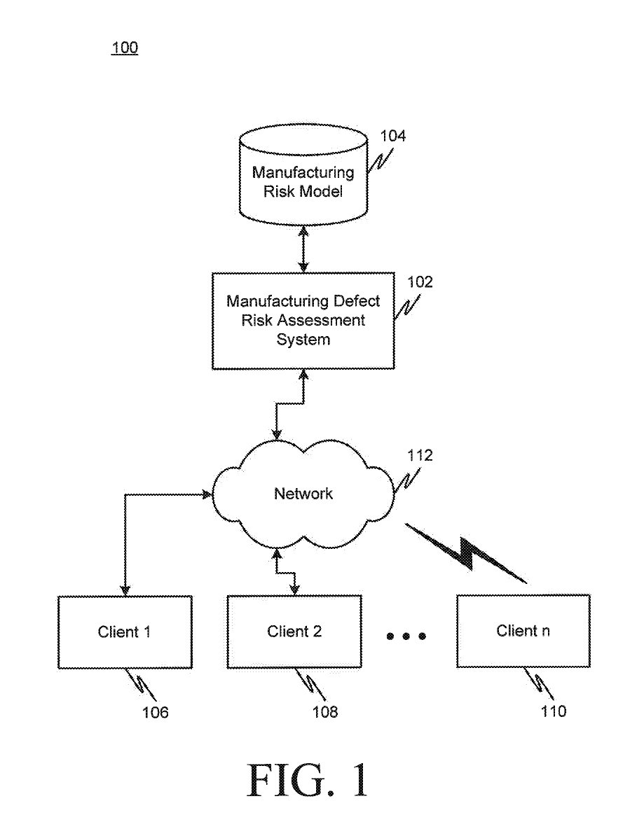

FIG. 1 shows an example environment 100 for multi-dimensional risk assessment, including loan manufacturing defect risk assessment. The environment 100 includes a manufacturing defect risk assessment system 102. The system 102 is coupled to a manufacturing defect risk model 104. A plurality of clients (106-110) can access the system via a network 112.

In operation, one or more of the client systems (106-110) provide information to the manufacturing defect risk assessment system 102, which, in turn, uses a portion of the supplied information as input to the manufacturing defect risk model 104. The manufacturing defect risk model 104 generates an estimate of manufacturing defect risk based on the input data.

The manufacturing defect risk model 104 can include a Bayesian inference network. A Bayesian inference network is a probabilistic graphical model (a type of statistical model) that represents a set of random variables and their conditional dependencies via a directed acyclic graph (DAG). For example, a Bayesian network in a model used in an implementation of the multi-dimensional risk assessment system could represent the probabilistic relationships between mortgage loan outcomes and borrower behavior, borrower information and/or operational factors, such as manufacturing defects. Given inputs of borrower behavior, borrower information and/or operational factors, the network can be used to compute the probabilities of various loan outcomes. Also, in addition to or as an alternative to a Bayesian inference network, the manufacturing defect risk model 104 can include one or more of a Markov random field (or Markov network), a factor graph (e.g., a undirected bipartite graph connecting variables and factors), a clique tree or junction tree for use in a junction tree algorithm, a chain graph having directed and/or undirected edges, directed acyclic graphs and/or undirected graphs, an ancestral graph, a conditional random field and/or a restricted Boltzmann machine.

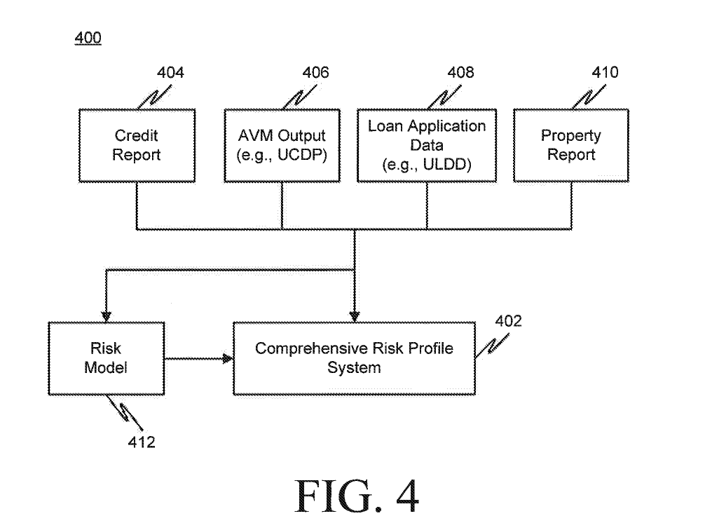

The manufacturing defect risk assessment system 102 can be a subsystem of a comprehensive multi-dimensional loan application risk estimate system (e.g., the comprehensive risk profile system 402 of FIG. 4) that includes manufacturing defect risk as one consideration among one or more other factors in estimating the risk of a loan application. Other dimensions can include real estate market data such as how housing prices have changed in a particular area, how prices have evolved over time, characteristics and conditions of a market, types of properties that are selling, and average time on market.

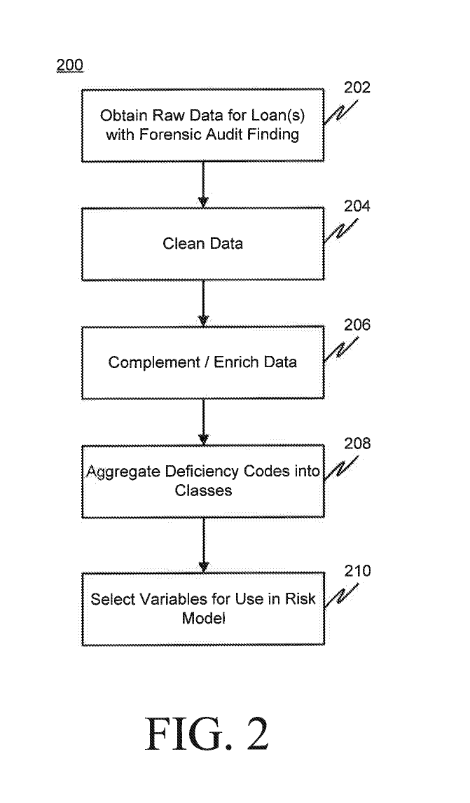

FIG. 2 is a flowchart showing an example method 200 for generating a loan manufacturing defect risk assessment model. Processing begins at 202, where raw loan data, including a forensic audit finding for each loan, is obtained. The model can be built using a data repository of loan information and audit findings associated with each loan. The data repository can include a statistically significant number of loans (e.g., more than one million).

The loan data can be provided in the form of a database that can include borrower data and property data. The borrower data can include the number of credit relationships, type of credit relationships, how encumbered the borrower is by all forms of credit, how the borrower services the credit relationships, the true monthly debt servicing obligations of the borrower, and how the borrower responds in distress. The property data can include property type, age, structure, equity (related to CLTV), value across multi-year period, and encumbrance level. Processing continues to 204.

At 204, the raw loan data is cleaned. For example, the loan data may have been modified during the course of a loan. These modifications are removed and the loan data is restored to the data values as of loan origination time. The raw loan data can include borrower income and employment information, bankruptcy documentation, accountant letters, asset documentation, gift letters, bank statements, debts, loan payment history, property valuation, and compliance requirements. Processing continues to 206.

At 206, the raw loan data is complemented (or enriched) with additional data. The additional data can include, for example, data from the sources shown in FIG. 4. Processing continues to 208.

At 208, deficiency codes associated with defects in the loans are aggregated into groups of related defects (e.g., income defects, property defects, and the like). These groups or clusters of related defects can establish dimensions for evaluation by the risk model. The deficiency codes can be generated from one or more audit findings associated with the loan. The audit findings can include indications of an error, a misrepresentation or fraud related to one or more of borrower income and employment information, bankruptcy documentation, accountant letters, asset documentation, gift letters, bank statements, debts, loan payment history, property valuation, and compliance requirements. Processing continues to 210.

At 210, variables are selected for use in a risk model. The variables are selected based on the correlation between the variable and a defect in the loans. For example, a model can include a predetermined number of dimensions (or clusters of one or more variables) that can help enable an analyst, underwriter, servicer or investor to make decisions regarding a loan. Processing continues to 212.

At 212, a model is created based on the selected variables.

The plurality of dimensions in a model can help determine which loans (or loan applications) may contain manufacturing defects that correlate to specific loan outcomes (e.g., default). Thus, the model can help identify, correct or avoid loans that are likely to contain manufacturing defects that may lead to an adverse outcome (e.g., default) for the lender or loan buyer.

A coefficient can be selected for each variable to weight the variable relative to the other variables in the model. It will be appreciated that 202-212 can be repeated in whole or in part in order to accomplish a contemplated risk model task.

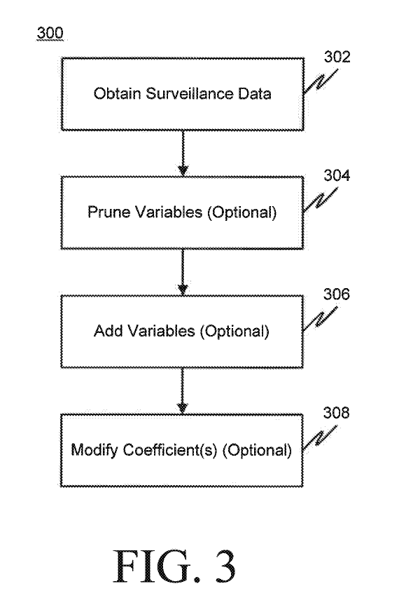

FIG. 3 is a flowchart of an example method for adapting a risk model. Processing begins at 302, where surveillance data is obtained. Surveillance data can include updated data and/or new data sources. Existing model performance is evaluated based on the surveillance data to determine if the existing model is performing adequately (e.g., above a certain threshold). If one or more existing models is not performing above a threshold, then processing continues to 304. Otherwise, processing stops, as the existing models are performing adequately in view of the surveillance data.

At 304, optionally, one or more variables are pruned. For example, if the statistical model indicates that a particular variable has lost relevance or significance over time, then that variable may be pruned (or de-emphasized via coefficient adjustment) from the set used to generate a score. Processing continues to 306.

At 306, optionally, one or more variables are added. An automatic or manual analysis or review of the statistical model may indicate that a variable that is not currently being considered may have a connection (or dependency) to a specific outcome that may be of interest and thus, the variable may be added to the model. Processing continues to 308.

At 308, optionally, one or more coefficients are modified. The coefficients (or weights) can be modified to emphasize or deemphasize a particular variable within a model. It will be appreciated that 302-308 can be repeated in whole or in part in order to accomplish a contemplated risk model adaptation task.

FIG. 4 is a diagram of an example system 400. The system 400 includes a comprehensive risk profile system 402. The comprehensive risk profile system 402 (and one or more risk models 412) receives a plurality of inputs including credit reports 404, AVM output 406 (e.g., information from a Uniform Collateral Data Portal or UCDP), loan application data 408 (e.g., information via Uniform Loan Data Delivery or ULDD) and/or property data 410. The system 402 also receives input from one or more risk models 412. The risk models 412 also receive input from sources 404-410.

In operation, the comprehensive risk profile system 402 uses the inputs (404-410) and output from the model(s) 412 to generate a comprehensive risk profile of a loan application. The risk profile can be used in loan underwriting or in other areas of the loan application process.

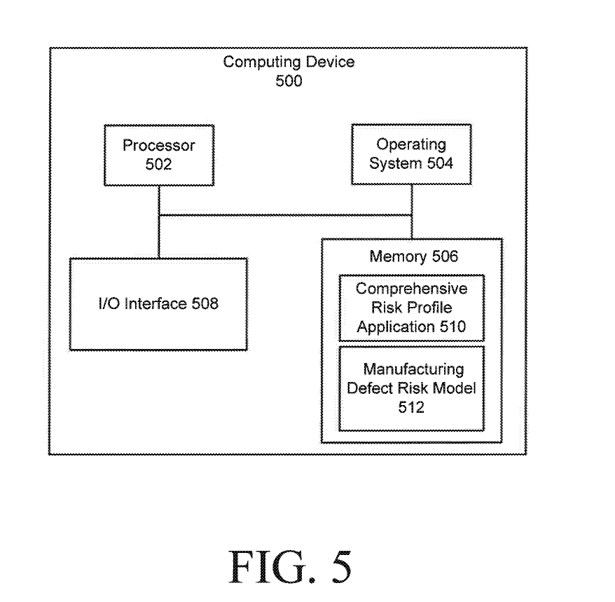

FIG. 5 is a diagram of an example computing device 500 that can be used as a multi-dimension risk assessment system in accordance with some implementations. The computing device 500 includes a processor 502, memory 506 and I/O interface 508. The memory 506 can include a comprehensive multi-dimension risk profile application 510 and a manufacturing defect risk model 512.

In operation, the processor 502 may execute the comprehensive risk profile application 510 stored in the memory 506. The multi-dimension risk profile application 510 can include software instructions that, when executed by the processor, cause the processor to perform operations for generating a comprehensive risk profile in accordance with the present disclosure (e.g., the multi-dimension risk profile application 510 can perform one or more of steps 202-210 and/or 302-308 described above, or steps 802-814 described below, and can access the risk model 512). The multi-dimension risk profile application 510 can also operate in conjunction with the operating system 504.

The multi-dimension risk profile computing device (e.g., 500) can include, but is not limited to, a single processor system, a multi-processor system (co-located or distributed), a cloud computing system, or a combination of the above.

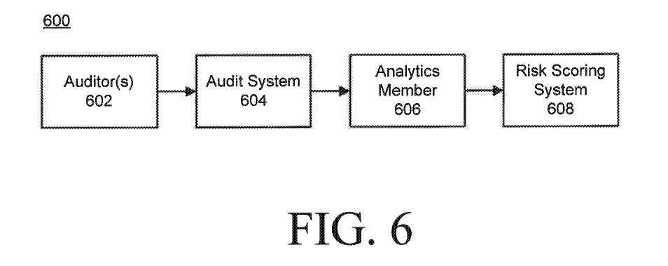

FIG. 6 is a diagram of an example data flow for loan manufacturing defect risk assessment model building in accordance with some implementations. The system 600 includes one or more auditors 602, an audit system 604, one or more analytics members 606 and a comprehensive risk scoring system 608.

The auditors 602 (which can be human auditors or automated auditors) review loan applications to determine, among other things, whether any manufacturing defects were present in the loan application or underwriting process. In addition to manufacturing defects, auditors may find and note errors, misrepresentations and/or fraud related to one or more of borrower income and employment information, bankruptcy documentation, accountant letters, asset documentation, gift letters, bank statements, debts, loan payment history, property valuation, and compliance requirements. Any findings of manufacturing defects (or other findings) are stored in a database in the audit system 604 and associated with the corresponding loan.

The audit findings stored in the audit system 604 can be analyzed by one or more analytics members 606 (a human analytics team member and/or an automated analytics system) and a portion of the audit and/or loan data can be used as training data for the manufacturing defect risk model, which can be used by the comprehensive risk scoring system 608. In addition to the manufacturing defect risk model, rules and policies can also be added to the comprehensive risk scoring system 608. The rules and policies can be specified by a lender, underwriter, or other entity.

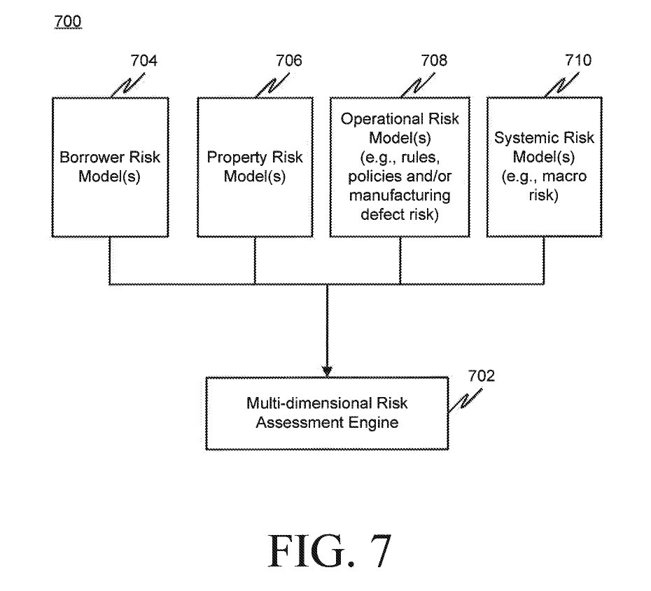

FIG. 7 is a diagram of a multi-dimensional risk assessment system in accordance with some implementations. The multi-dimensional risk assessment system 700 includes a multi-dimensional risk engine 702 coupled to a plurality of risk models including one or more borrower risk models 704, one or more property risk models 706, one or more operational risk models 708 and, optionally, one or more systemic risk models 710.

In operation, the risk models (704-710) receive input data and generate scores according to each respective model. The multi-dimensional risk assessment engine 702 receives the output from the models (704-710) (and optionally receives the input data) and transforms the model outputs into a multi-dimensional risk score for output to a user or another system.

It will be appreciated that data from one or more sources associated with a model (e.g., 704-710) could be used (individually or combined) in a different model.

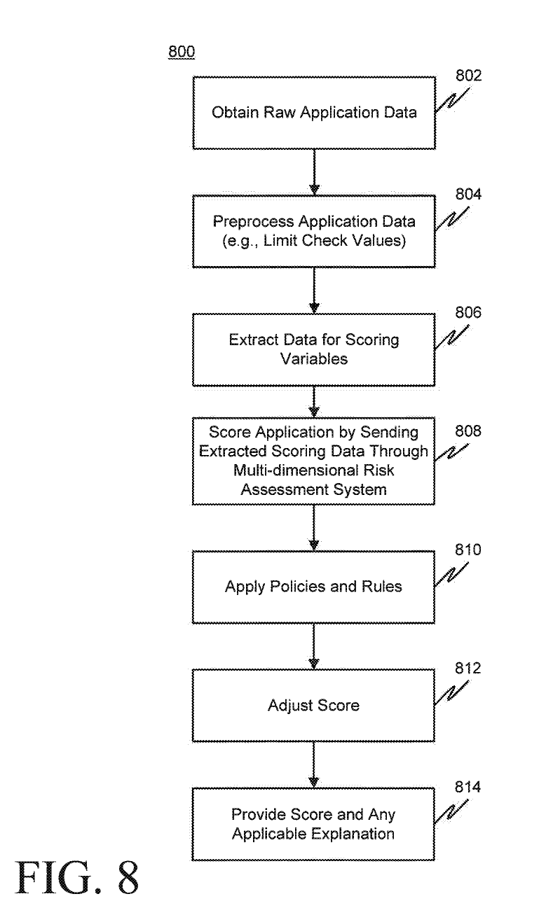

FIG. 8 is a flow chart showing an example method for multi-dimensional risk assessment system in accordance with some implementations. Processing begins at 802, where raw loan application data is obtained. In addition to loan application data, other data such as credit score, AVM and property information may also be obtained. Processing continues to 804.

At 804, the application data is preprocessed. For example, values in the loan application may be limit checked. Processing continues to 806.

At 806, key scoring variable values are selected from the loan application data. For example, key scoring variables can be one or more variables used in one or more of the risk models (e.g., 104) constituting a part of the multi-dimensional risk assessment system. Processing continues to 808.

At 808, the application is scored by processing the selected variables in one or more of the risk models of the multi-dimensional risk assessment system. A score can be generated that represents an overall risk assessment for the loan based on the multi-dimensional analysis. Processing continues to 810.

At 810, policies and rules are applied to the score. For example, each lender or underwriter may have specific policies and/or rules that must be followed. Even though an application may receive a score that suggests approval (e.g., is within the risk parameters of an organization), a policy and/or rule may indicate that the loan is not suitable. For example, a particular lender may have a policy that a borrower may only have a specified number of outstanding loans with that lender. Continuing with the above example, if a borrower applies for a sixth loan and is otherwise qualified based on the multi-dimensional risk assessment, the policy is applied to indicate that the loan should not be approved. Processing continues to 812.

At 812, the score is adjusted according to the policies and rules that have been applied. For example, if an application has a score that suggests approval, but does not meet a policy or rule, then the score may be lowered to 0 (on a scale where a lower score indicates a higher risk) so that the loan is not approved. Processing continues to 814.

At 814, the adjusted score and any applicable explanations are provided as output. The score and any output from the one or more risk models can be provided as output. The system can also provide a list of one or more areas that may require further investigation before a loan is approved. These may be areas of concern, but not necessarily indicators for disapproving a loan. It will be appreciated that 802-814 can be repeated in whole or in part in order to accomplish a contemplated multi-dimensional risk assessment task.

The systems, methods and computer readable media described herein have been discussed in terms of mortgage loans for illustration purposes. It will be appreciated that the systems, methods and computer readable media can be configured for risk assessment in other industries. In general, an implementation can be configured for any industry in which a multi-dimensional risk assessment would be desirable.

The client (or user) device(s) can include, but are not limited to, a desktop computer, a laptop computer, a portable computer, a tablet computing device, a smartphone, a feature phone, a personal digital assistant, a media player, televisions, an electronic book reader, an entertainment system of a vehicle, or the like. Also, user devices can include wearable computing devices (e.g., glasses, watches and the like), furniture mounted computing devices and/or building mounted computing devices.

The user devices can be connected to a notification platform via a network (e.g., 112). The network connecting user devices to the notification platform can be a wired or wireless network, and can include, but is not limited to, a WiFi network, a local area network, a wide area network, the Internet, or a combination of the above.

The data storage, memory and/or computer readable medium can be a magnetic storage device (hard disk drive or the like), optical storage device (CD, DVD or the like), electronic storage device (RAM, ROM, flash, or the like). The software instructions can also be contained in, and provided as, an electronic signal, for example in the form of software as a service (SaaS) delivered from a server (e.g., a distributed system and/or a cloud computing system).

Moreover, some implementations of the disclosed method, system, and computer readable media can be implemented in software (e.g., as a computer program product and/or computer readable media having stored instructions for detecting exposure quality in images as described herein). The stored software instructions can be executed on a programmed general purpose computer, a special purpose computer, a microprocessor, or the like.

It is, therefore, apparent that there is provided, in accordance with the various example implementations disclosed herein, systems, methods and computer readable media for multi-dimensional risk assessment.

While the disclosed subject matter has been described in conjunction with a number of implementations, it is evident that many alternatives, modifications and variations would be or are apparent to those of ordinary skill in the applicable arts. Accordingly, Applicants intend to embrace all such alternatives, modifications, equivalents and variations that are within the spirit and scope of the disclosed subject matter.

What is claimed is:

1. A computerized method for generating a manufacturing defect risk assessment model, the method comprising:
obtaining, using one or more processors, loan application data;
preprocessing the loan application data, using the one or more processors, the preprocessing including limit checking values and augmenting the loan application data with information from external sources;
selecting, using the one or more processors, scoring values corresponding to key scoring variables;
scoring the application, using the one or more processors, by processing the scoring values in a multi-dimensional risk assessment system including an operational risk model;
generating a raw score based on the scoring;
applying, using the one or more processors, one or more policies and rules; and
adjusting, using the one or more processors, the raw score based on a result of applying the one or more policies and rules.

2. The method of claim 1, wherein the information from external sources includes one or more of credit reports, information from a Uniform Collateral Data Portal, information received via Uniform Loan Data Delivery and property data.

3. The method of claim 1, wherein the operational risk model includes a manufacturing defect risk assessment model.

4. The method of claim 3, wherein the manufacturing defect risk assessment model is trained with loan application data and at least one forensic audit finding.

5. The method of claim 3, wherein the manufacturing defect risk assessment model includes a Bayesian inference network.

6. The method of claim 4, wherein the forensic audit finding includes information about any misrepresentations or errors arising from loan manufacturing.

7. A nontransitory computer readable medium having stored thereon software instructions that, when executed by a processor, cause the processor to perform operations including:
obtaining loan application data;
preprocessing the loan application data including limit checking values and augmenting the loan application data with information from external sources;
selecting scoring values corresponding to key scoring variables; and
scoring the application by processing the scoring values in a loan manufacturing defect risk model and generating a raw score.

8. The nontransitory computer readable medium of claim 7, wherein the information from external sources includes one or more of credit reports, information from a Uniform Collateral Data Portal, information received via Uniform Loan Data Delivery and property data.

9. The nontransitory computer readable medium of claim 7, wherein the operational risk model includes a manufacturing defect risk assessment model.

10. The nontransitory computer readable medium of claim 9, wherein the manufacturing defect risk assessment model is trained with loan application data and at least one forensic audit finding.

11. The nontransitory computer readable medium of claim 9, wherein the manufacturing defect risk assessment model includes a Bayesian inference network.

12. The nontransitory computer readable medium of claim 10, wherein the forensic audit finding includes information about any misrepresentations or errors arising from loan manufacturing.

13. A computerized system comprising:
a processor configured, through software instructions stored on a nontransitory computer readable medium, to perform a series of operations including:
obtaining loan application data;
preprocessing the loan application data including limit checking values and augmenting the loan application data with information from external sources;
selecting scoring values corresponding to key scoring variables; and
scoring the application by processing the scoring values in a loan manufacturing defect risk model and generating a raw score.

14. The system of claim 13, wherein the operational risk model includes a manufacturing defect risk assessment model.

15. The system of claim 14, wherein the manufacturing defect risk assessment model is trained with loan application data and at least one forensic audit finding.

16. The system of claim 14, wherein the manufacturing defect risk assessment model includes a Bayesian inference network.

17. The system of claim 15, wherein the forensic audit finding includes information about any misrepresentations or errors arising from loan manufacturing.

18. The system of claim 14, wherein the manufacturing defect risk assessment model also includes one or more rules and one or more policies, wherein the one or more rules and one or more policies are configured to be applied to an output of the model to adjust a risk score produced by the model.

19. The system of claim 13, wherein the information from external sources includes one or more of credit reports, information from a Uniform Collateral Data Portal, information received via Uniform Loan Data Delivery and property data.
